(19) United States
(12) Patent Application Publication
(10) Pub. No.: US 2005/0180906 A1
(43) Pub. Date: Aug. 18, 2005

(54) Ethylene oxide decomposition processing method and decomposition processing device therefor

(76) Inventors: Kunimasa Muroi, Hamamatsu-shi (JP); Jun Yamamoto, Hamamatsu-shi (JP); Akira Osawa, Hamamatsu-shi (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/982,877

(22) Filed: Nov. 8, 2004

(30) Foreign Application Priority Data
Nov. 10, 2003 (JP) 2003-379874

(51) Int. Cl. B01D 53/72

(52) U.S. Cl. 423/245.1; 422/188; 422/231

(57) ABSTRACT

A decomposition processing method for ethylene oxide is provided for when concentration of the ethylene oxide to be decomposed in a gas varies. The method comprises steps of reducing the concentration of ethylene oxide in the gas to a predetermined concentration which is less than the highest concentration of the ethylene oxide in the range of the variation, adsorbing ethylene oxide to a photocatalyst which has ethylene oxide adsorbing ability, and decomposing ethylene oxide by action of one of the photocatalyst and a combination of the photocatalyst and plasma. The adsorbing step and decomposing step are conducted after the reducing step.

### BACKGROUND OF THE INVENTION

1. Field of the Invention

The present invention relates to an ethylene oxide decomposition processing method and to a decomposition processing device therefor.

Priority is claimed on Japanese Patent Application No. 2003-379874, filed Nov. 10, 2003, the content of which is incorporated herein by reference.

2. Description of Related Art

When a sterilization processing with a sterilization device using ethylene oxide is conducted and an exhaust gas is discharged from the sterilization device after the sterilization processing is completed, the gas contained in the device is withdrawn to be discharged from the sterilization device. Outside air is not introduced into the sterilization device in the initial stage of the discharge of the exhaust gas. For this reason, the exhaust gas in the initial stage has a high ethylene oxide concentration. In particular, when a sterilization device comprises a cartridge type cylinder as a source of ethylene oxide, the ethylene oxide concentration in the exhaust gas is about 100%. The ethylene oxide concentration in the exhaust gas may decrease rapidly by the outside air introduction thereto as the discharge of the exhaust gas from the sterilization device proceeds.

Furthermore, in order to remove the ethylene oxide adhering to sterilized material such as gauze contained in the sterilization device, since ethylene oxide adheres in the sterilization processing, an operation is performed so that a process called “cleaning” is conducted several times. The cleaning is conducted both by an introduction of outside air into the sterilization device and a drawing of a gas contained in the device wherein the drawing is conducted after a short period has been passed from the introduction. The concentration of the ethylene oxide in the exhaust gas which is discharged in the cleaning process changes.

In this way, when the ethylene oxide in the exhaust gas, in which a variation in ethylene oxide concentration is large, is decomposed with a conventional method using an oxidation catalyst, excess ethylene oxide, which exceeds the throughput of the catalyst, is discharged without decomposition thereof, if throughput of the oxidation catalyst cannot be appropriate for the maximum concentration of ethylene oxide included in the exhaust gas. Therefore, there is a problem because the cost for the decomposition processing device increases since large amounts of oxidation catalyst must be used.

In order to overcome this problem, a method in which a treated exhaust air is sent into a decomposition processing device, after a concentration of the ethylene oxide contained in the exhaust gas is decreased by reducing variation in ethylene oxide concentration in the exhaust gas, is proposed in WO 99/61137.

In this prior art, the exhaust gas is introduced from sterilization device (not shown) into a container 1 which stores liquid such as water, through a pipe 2 and a valve 3, as shown in FIG. 8. Then, an aeration (a bubbling) of the introduced exhaust gas is conducted by exposing the gas to the liquid by an aeration member 4 in order to dissolve and adsorb the ethylene oxide in the exhaust gas into the liquid. Most of the ethylene oxide in the exhaust gas is absorbed by the liquid. The exhaust gas wherein the ethylene oxide concentration is greatly reduced is sent from the container 1 to the catalytic combustion device 6, in which the oxidation catalyst is filled, via the pipe 5, and then decomposition processing is carried out in the device.

When the ethylene oxide concentration in the exhaust gas supplied from the sterilization device decreases, an air supply pump 7 is operated to send outside air to the pipe 2. The sent outside air is allowed to bubble into the liquid in the container 1 so that the ethylene oxide dissolved in the liquid passed into the air. The air in which the ethylene oxide is transferred is sent into the catalytic combustion device 6 to carry out a decomposition processing of the ethylene oxide.

By using the aforementioned decomposition processing method, the range of variation in the ethylene oxide concentration in the exhaust gas, which is large, can be reduced, and the concentration of the ethylene oxide can be standardized. In the document, there are described those in which, since the ethylene oxide concentration becomes low even if a high concentration of ethylene oxide is in the exhaust gas, the exhaust gas containing the high concentration ethylene oxide is not sent into the catalytic combustion device 6, and therefore the catalytic combustion device 6 can be miniaturized, and device cost can be reduced.

However, the decomposition processing method for the ethylene oxide described in the document has the following problems.

Firstly, since the oxidation catalyst is used as a decomposition mean for ethylene oxide, the temperature of the exhaust gas which is exhausted after the decomposition is high (300 to 400° C.). Therefore, exhaust gas at such a temperature cannot be discharged as it is, and a cooling device and/or a dilution device using the outside air must be provided.

Moreover, undecomposed ethylene oxide may be discharged from the system, when the ethylene oxide concentration in the exhaust gas sent from the container 1 is not reduced sufficiently for some reason and therefore an exhaust gas including ethylene oxide in excess concentration, which exceeds a throughput of the oxidation catalyst, is transferred into the catalytic combustion device 6.

Furthermore, the exhaust gas may leak to the outside of the device, since the overall device for the decomposition processing may have a positive pressure provided by the operation of an air supply pump 7 and the like. Accordingly, in order to avoid these problems, excessive device cost is incurred to provide a system which is very airtight.

### SUMMARY OF THE INVENTION

An object of the present invention is to provide a decomposition processing method and a decomposition processing device for ethylene oxide, with which the exhaust gas after decomposition processing does not have a high temperature, and the undecomposed ethylene oxide is not discharged out of the processing system, even if exhaust gas containing a high-concentration of ethylene oxide flows into a decomposition processing means for some reason. Moreover, it is also the object of the present invention to provide a decomposition processing method and device for ethylene oxide, wherein the exhaust gas which contains ethylene oxide does not leak to the outside of the decomposition processing device.

In order to achieve the aforementioned objects, the inventors of the present invention provided the following processing method and processing device. That is, the first aspect of the present invention is a decomposition processing method for ethylene oxide, in which the concentration of the ethylene oxide to be decomposed in a gas varis, and the method comprises the steps of: reducing the concentration of ethylene oxide in the gas to a predetermined concentration which is less than the highest concentration of the ethylene oxide in the range of the variation; adsorbing the ethylene oxide by a photocatalyst which has ethylene oxide adsorbing ability; and decomposing the ethylene oxide by action of one of the photocatalyst and a combination of the photocatalyst and plasma, the adsorbing step and decomposing step are conducted after the reducing step.

Preferably, the reducing step of the method of the first aspect of the present invention may include a sub-step wherein the predetermined concentration of ethylene oxide is controlled so that the predetermined concentration of ethylene oxide is determined not to exceed the adsorbing ability of the photocatalyst; and a value, which is obtained by subtracting an integral value of decomposition ability of one of the photocatalyst and the combination of the photocatalyst and the plasma from the start of processing to a point wherein a predetermined time is passed from the start, from an integral value of injection concentration of the ethylene oxide from the start of processing to a point wherein a predetermined time is passed from the start, does not exceed the adsorbing ability of the photocatalyst. That is, the predetermined concentration of ethylene oxide may be within the adsorbing ability of the photocatalyst, and the value obtained by the substration may be the adsorbing ability of the photocatalyst or less.

The second aspect of the present invention is a decomposition processing method for ethylene oxide, wherein the concentration of the ethylene oxide to be decomposed in a gas varies, and the method comprises the steps of: reducing an ethylene oxide concentration in a gas to a predetermined concentration which is less than the highest concentration of the ethylene oxide in the range of the variation;

adsorbing ethylene oxide by an adsorbent which has ethylene oxide adsorbing ability; and decomposing ethylene oxide by action of plasma,

the adsorbing step and decomposing step are conducted after the reducing step.

Preferably, the reducing step of the method of the second aspect of the present invention may comprises a sub-step wherein the predetermined concentration of ethylene oxide is controlled so that the predetermined concentration of ethylene oxide is determined not to exceed the adsorbing ability of the adsorbent; and a value, which is obtained by subtracting the integral value of decomposition ability of the plasma from the start of processing to a point wherein a predetermined time is passed from the start from the integral value of injection concentration of the ethylene oxide from the start of processing to a point wherein a predetermined time is passed from the start, does not exceed the adsorbing ability of the adsorbent.

In the first and second aspects of the present invention, it is preferable that decomposition rate of the aforementioned decomposition is lower than rate of the adsorption.

In the first and second aspects of the present invention, it is preferable that the control of the predetermined concentration of ethylene oxide be conducted by a bubbling (aeration) of the gas comprising ethylene oxide in water.

In the first and second aspects of the present invention, it is preferable that the overall system of decomposition processing have a negative pressure.

The third aspect of the present invention is a decomposition processing device for ethylene oxide in which concentration of the ethylene oxide to be decomposed comprised in a gas varies, wherein the device comprising: a buffer part which reduces ethylene oxide concentration in a gas to a predetermined concentration which is less than the highest concentration of the ethylene oxide in the range of the variation; and a decomposition part which decomposes ethylene oxide in the gas sent from the buffer part, wherein the decomposition part comprises one of a photocatalyst member which has ethylene oxide adsorbing ability and a combination of the photocatalyst member and a plasma device.

The fourth aspect of the present invention is a decomposition processing device of ethylene oxide in which concentration of the ethylene oxide to be decomposed in a gas varies, the device comprising: a buffer part which reduces the ethylene oxide concentration in the gas to a predetermined concentration which is less than the highest concentration of the ethylene oxide in the range of the variation; and a decomposition part which decomposes ethylene oxide in the gas sent from the buffer part, wherein the decomposition part comprises an adsorbent which has ethylene oxide adsorbing ability and a plasma device.

It is preferable that the buffer part of the third and fourth aspects of the present invention be an aeration tank, which has a tank filled with water and an air diffusing pipe which can bubble ethylene oxide in water held in the tank.

It is also preferable that a downstream part of the decomposition part be provided, and the downstream part be an exhauster which can provide negative pressure to the buffer part and the decomposition part.

### BRIEF DESCRIPTION OF THE DRAWINGS

FIG. 1 is a schematic view which shows an example of a constitution of a decomposition processing device of the present invention.

FIG. 2 is a schematic view which shows an example of a constitution of the buffer part of the present invention.

FIG. 3 is a schematic view which shows the first example of a constitution of a combined form of the photocatalyst and the plasma.

FIG. 4 is a schematic view which shows the second example of a constitution of a combined form of the photocatalyst and the plasma.

FIG. 5 is a schematic view which shows the third example of a constitution of a combined form of the photocatalyst and the plasma.

FIG. 6 is a graph which shows an example of temporal variation in the ethylene oxide concentration in the exhaust gas discharged from a sterilization chamber and temporal variation of the ethylene oxide concentration in the exhaust gas discharged from the buffer part.

FIG. 7 is a schematic view which shows another example of a constitution of the decomposition processing device of the present invention.

FIG. 8 is a schematic view which shows a constitution of a decomposition processing device for ethylene oxide of the prior art.

### DETAILED DESCRIPTION OF THE INVENTION

Preferred embodiments of the present invention are described below. However, the present invention is not limited to these embodiments. Any addition, omission, substitution, and other changes are possible insofar as they do not interfere with the aims of the present invention. This invention is not limited by the aforementioned description and the present invention is limited only by the scope of the claims of the present application.

The present invention relates to a decomposition processing of ethylene oxide which is used for sterilization processing of medical implements, organic synthesis, and the like. The object to be processed in the present invention is an exhaust gas containing ethylene oxide discharged after the sterilization processing. The processing of ethylene oxide in the exhaust gas of the present invention can be conducted with good efficiency.

In the present invention, at least one of a photocatalyst and a plasma is used as a decomposition processing means for ethylene oxide. Accordingly, the temperature of the exhaust gas after decomposition processing of ethylene oxide is low, and therefore it can be discharged as it is. Furthermore, since decomposition processing by a photocatalyst and/or plasma is performed, processing efficiency is good, and complicated processing such as circulation processing is not required. Furthermore, since at least one of a photocatalyst and the adsorbent may have the adsorption capability of ethylene oxide, even if the exhaust gas containing high concentration ethylene oxide flows to a photocatalyst and adsorbent, a photocatalyst and/or adsorbent can be adsorbed by the photocatalyst and the adsorbent. Then, decomposition processing of the ethylene oxide may be gradually carried out after this adsorption. In this way, undecomposed ethylene oxide is not discharged from the device, and even the photocatalyst or plasma having small decomposition capability in a decomposition part can cope with the ethylene oxide introduced in the decomposition part. Furthermore, by making the overall decomposition processing device have a negative pressure, the exhaust gas containing ethylene oxide cannot leak to the outside from the device.

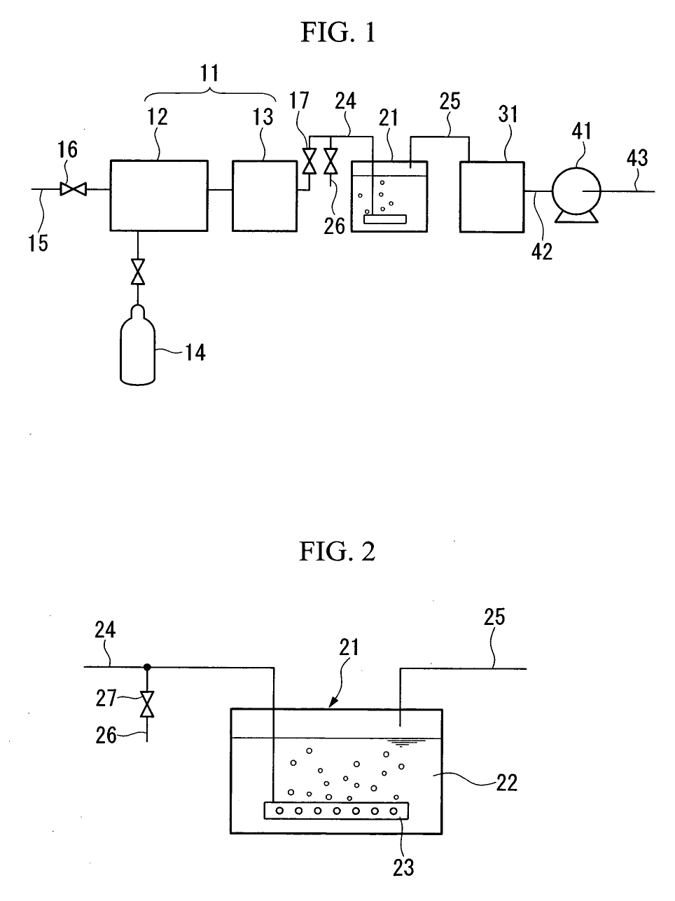

FIG. 1 shows an example of the decomposition processing device of the present invention. The decomposition processing device of the example is structured schematically with a sterilization part 11, a buffer part 21, a decomposition part 31, and the exhaust part 41. The above-mentioned sterilization part 11 comprises a sterilization chamber 12 and an ejector 13. The sterilization chamber 12 contains therein components which should be sterilized, an example thereof being various medical implements and the like such as a syringe. The gaseous ethylene oxide is introduced into the sterilization chamber 12 from the ethylene oxide supply sources 14 such as a cartridge type cylinder, which is provided separately. Then, sterilization processing of the contained items which are to be sterilized is carried out in the chamber. Moreover, a pipe 15 open to the outside air is connected to the sterilization chamber 12 via the valve 16, and the outside air may be introduced from the pipe 15.

An ejector 13 using the compressed air from a compressed air source, which is not shown, is attached to the sterilization chamber 12. The ejector 13 has a function in which the ejector discharges the exhaust gas containing the ethylene oxide in the sterilization chamber 12 to the outside. An exhaust device such as a vacuum pump may be used instead of the ejector 13. The buffer part 21 is provided in the latter part of this sterilization part 11.

The buffer part 21 shown in the FIG. 1 as an example is an aeration tank which includes a tank 22 wherein the inside thereof is filled with water as shown in FIG. 2. In this tank 22, a gas diffusing pipe 23 for bubbling is immersed in water, and the exhaust gas is subjected to bubbling in water from the gas diffusing pipe 23, in which the gas flows into the gas diffusing pipe 23 through a pipe 24 from the sterilization part 11 via a valve 17. A pipe 25 which has at least one opening away from the water surface is attached to the upper part in the tank 22. The pipe 25 is connected to the decomposition part 31, and the exhaust gas sent from the buffer part 21 is further sent to the decomposition part 31 provided downstream thereof.

The pipe 26 which is open to outside air is connected to the pipe 24 via the valve 27. When the valve 27 is open, outside air is sent from the pipe 26 through the pipe 24, and the air can be aerated in the water from the gas diffusing pipe 23. The number and form of the air diffusing pipe 27 can be selected optionally in accordance with need. Furthermore, the number, form, arrangement, and the like, of the air diffusing pores of the gas diffusing pipe 23 can be selected optionally in accordance with need.

The bubbling from the gas diffusing pipe 23 in the buffer part 21 and inflow of the exhaust gas from the pipe 25 to the decomposition part 31 may be due to the negative pressure in the water tank 22 and in the decomposition part 31, which pressure is generated based on the exhaust caused by the aforementioned exhaust part 41. The exhaust may be carried out, instead of providing the exhaust part 41 for the exhaust, by introducing outside air as a compressed air in order to perform the exhaust and by providing a positive pressure to the inside of the buffer part 21 and inside of the decomposition part 31.

The decomposition part 31 is provided downstream of the buffer part 21. This decomposition part 31 is equipped with a photocatalyst device, or a photocatalyst device and a plasma decomposition device. The decomposition part 31 decomposes the ethylene oxide in the exhaust gas supplied from the buffer part 21 through a pipe 25, by action of a photocatalyst or a photocatalyst and a plasma. The aforementioned photocatalyst device is equipped with a photocatalyst member and a light source which emits an ultraviolet ray, visible light and the like.

The photocatalyst member is not limited in particular. For example, the kind, form, number, arrangement, and the like thereof may be selected optionally in accordance with requirements. A well-known form of a photocatalyst member may be used as a form of the photocatalyst member in the present invention. Examples thereof include a form wherein titanium oxide powder capable of adsorbing ethylene oxide or a titanium oxide powder, on which is further carried out compression molding processing, is supported by any of various carriers in various forms, and a form wherein titanium oxide powder capable of adsorbing ethylene oxide or a titanium oxide powder, on which is further carried out compression molding processing, is fixed to a substrate by using any of various binders such as resin.

The titanium oxide powder having an anatase form crystal structure can be mainly used as the titanium oxide powder used in the present invention. Titanium oxide powders which can exhibit a catalyst function not only by ultraviolet ray but also by irradiation of visible light, are preferable.

A material having hydrophilicity and adsorptivity may be employed for forming the aforementioned carrier or substrate which can constitute the form of the photocatalyst member, to provide a higher adsorptivity of ethylene oxide to the photocatalyst member. Material used as the carrier or substrate which has hydrophilicity and adsorptivity can be selected optionally. Examples thereof include zeolite, silica gel, diatom earth, and titanium oxide. These materials may be used alone or in combination of two or more kinds. It is preferable that the photocatalyst member have the shape of a tablet, a grain, or a honeycomb, since surface area of the shape is large and adsorption ability thereof is high.

The conditions of the aforementioned plasma decomposition device are not limited in particular. For example, the kind, form, number, arrangement, and the like thereof may be selected optionally in accordance with requirements. Examples thereof to be used include conventionally known device using nonequilibrium plasma and the like. As an electric discharge form which forms the nonequilibrium plasma, pulse streamer electric discharge, silent electric discharge, partial discharge, creeping discharge, and the like may be used. Among these, the creeping discharge system is preferable since generation of nitrogen oxide (NO_{X}) can be suppressed.

Furthermore, when a photocatalyst and nonequilibrium plasma are used in combination, higher decomposition efficiency can be achieved by employing a composite form such as those described below.

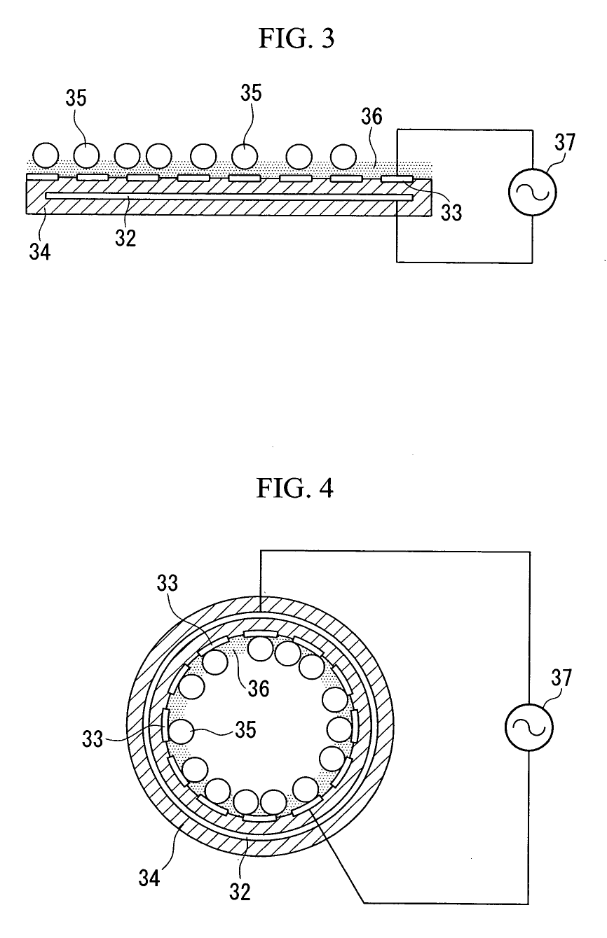

FIG. 3 shows the first example of the composite form. The number 32 in the FIG. 3 indicates the first electrode, and the second electrode 33 is provided such that it stands face to face against this first electrode 32. The first electrode 32 is embedded in the substrate 34 which is made from a dielectric material, and the second electrode 33 is located on the surface of the substrate 34. A granular photocatalyst member 35 is disposed on the second electrode 33. Alternatively, the granular photocatalyst member 35 may be fixed to a fixed bed 36 and may be located on the electrode 33. Furthermore, the first electrode 32 and the second electrode 33 are connected to an alternating current power source 37 so that alternating voltage is applied thereto.

In such a composite form, in addition to decomposition action of the photocatalyst and the plasma which have the action originally, a decomposition of ethylene oxide can proceed since the photocatalyst is excited by the plasma itself, visible light, or ultraviolet ray by emission from the plasma. Furthermore, ozone generated by the plasma can raise the decomposition efficiency of the photocatalyst. Furthermore, since the carbon monoxide generated by plasma changes to carbon dioxide due to an oxidation of the photocatalyst, there are effects such that a generation rate of harmful carbon monoxide can be reduced.

FIG. 4 shows the second example of the composite form. The numbers used for components in the figure are the same as those used in FIG. 3, and the explanation is simplified. In the example, the substrate 34 which is made from a dielectric material has a cylindrical shape, and the second electrode 33 and the photocatalyst member 35 are located on the inner circumference side. In this form, ethylene oxide is decomposed by passing an exhaust gas in the cavity in the substrate 34.

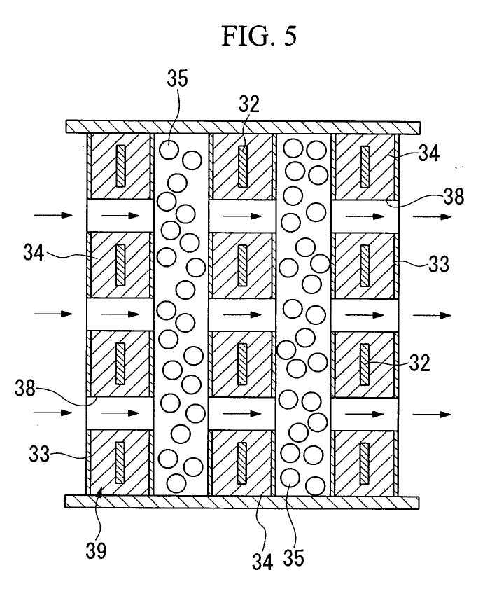

FIG. 5 shows the third example of the composite form. The numbers used for components in the figure are the same as those used in FIG. 3, and the explanation is simplified. In this example, the first electrode 32 is located inside of the plate substrate 34, and the second electrode 33 is located on the surface of the substrate. There are plural through holes 38 which pass through the substrate 34 in the thickness direction thereof. Plural electric discharge units 39 which form the aforementioned formation are placed at intervals, and the granular photocatalyst member 35 is filled in the intervals. An alternating current power source is not shown in this figure. In this composite, a decomposition processing of the ethylene oxide in the exhaust gas is carried out by passing the exhaust gas through each through hole 38 of the electric discharge unit 39.

The exhaust part 41 is located downstream of the decomposition part 31. While the exhaust part 41 exhausts a gas to the outside due to suction, wherein the gas has been subjected to the decomposition processing and sent from the decomposition part 31 through a pipe 42, the exhaust part 41 provides a negative pressure to the inside of the buffer part 21 and the decomposition part 31 which are provided at the forward position of the exhaust part 41. A common vacuum pump, a common ejector, and the like may be used for the exhaust part 41. The gas which has been subjected to the decomposition processing and is discharged from the exhaust part 41 is released from the pipe 43 to the outside of the system. The exhaust part 41 is always in an operating state, and a negative pressure at the inside of the decomposition part 31 and the buffer part 21 is always provided.

Next, a processing method for the exhaust gas containing ethylene oxide wherein the method is conducted by using the decomposition processing device is explained.

After sterilization processing is completed in the sterilization chamber 12, an exhaust gas having high ethylene oxide concentration is discharged from the chamber by operating the ejector 13, and the exhaust gas is sent to the buffer part 21 via the pipe. Subsequently, the valve 16 is opened, and the ejector 13 is intermittently operated to introduced an outside air into the sterilization chamber 12 through a pipe 15. By the introduction, ethylene oxide remaining in the sterilization chamber 12 and ethylene oxide adhering and adsorbing to the processing object to be sterilized are expelled from the inside, and the exhaust gas including the ethylene oxide is sent to the buffer part 21. It is desirable that the operation of this introduction (cleaning process) be conducted two or more times.

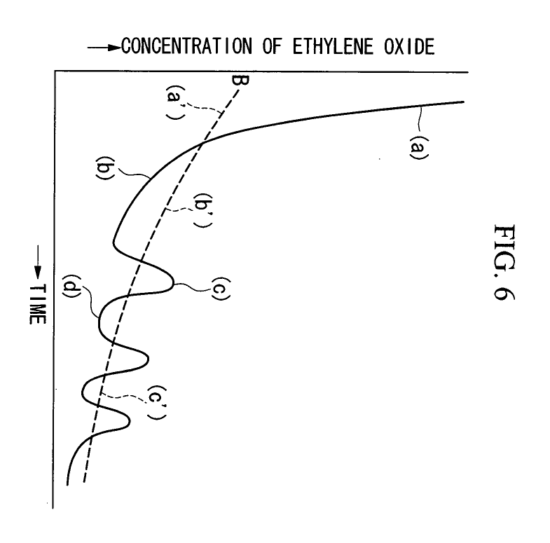

In these operations, when the ethylene oxide concentration of the exhaust gas discharged from the sterilization part 11 is measured as it is, the temporal variation of the concentration starts from high concentration of nearly 100%, and then shows a rapid and large change thereof. This ethylene oxide concentration is shown as a continuous line A in FIG. 6. In the figure, the concentration of ethylene oxide is provided on the ordinate, and the time from a processing start is provided on the abscissas. This variation is similar to those of the ethylene oxide concentration of the exhaust gas of the prior art explained above, and an exhaust gas in an early stage shows high concentration (a) which is nearly 100% due to the gas suction in the sterilization part 11. As discharge progresses, the concentration of the ethylene oxide decreases rapidly to have the concentration (b). Subsequently, when the valve 16 is closed and discharge is stopped and the sterilization chamber 12 is maintained at a negative pressure, the ethylene oxide adhering to gauze and the like is emitted and then the concentration of the ethylene oxide in the sterilization chamber 12 become high again. Next, the valve 16 is opened again and this exhaust gas in the chamber is withdrawn, the ethylene oxide concentration which was been low, changes to a concentration (c) which is high to some extent. However, when the gas is discharged again, concentration thereof provides a decreased value again to be the concentration (d).

As a result of repeating these operations, the range of variation of ethylene oxide concentration becomes small over time. Ethylene oxide concentration also becomes small gradually, and the concentration becomes about 0% after several minutes to several tens of minutes have passed.

The buffer part 21 can reduce a wide variation of the ethylene oxide concentration. The buffer part 21 reduces the concentration of the ethylene oxide discharged from the sterilization chamber 12, until it becomes at least a concentration which is not greater than the highest concentration of the ethylene oxide discharged from the sterilization chamber 12. Concretely, it is preferable that the ethylene oxide concentration comprised in the exhaust gas discharged from the buffer part 21 be 30,000 ppm or less, since 30,000 ppm is the explosion limit of the ethylene oxide. It is more preferably 10,000 ppm or less, and is still more preferably 3,000 ppm or less.

The exhaust gas from the sterilization part 11 is bubbled in water from the gas diffusing pipe 23 of the buffer part 21 through the pipe 24. The ethylene oxide in the exhaust gas is water soluble, and therefore it is easily dissolved in water. When the ethylene oxide concentration of the exhaust gas is high in early stages of the discharge, most of the ethylene oxide in the gas is dissolved in water, and a portion of ethylene oxide which cannot be dissolved in water shifts into air from the water wherein the aeration is conducting. As the result, exhaust gas, in which ethylene oxide concentration thereof is reduced, is discharged from a pipe 25, and it is sent to the decomposition part 31. The aeration using the gas diffusing pipe 23 at the buffer part 21 is performed continuously by continuous operation of the exhaust part 41.

In the aforementioned cleaning process, most of the exhaust gas discharged from the sterilization part 11 is air. By aerating the exhaust gas from the gas diffusing pipe 23, the ethylene oxide, which have been dissolved in water previously, gasifies, and the gasfied ethylene oxide passes from the water into air. Then, it is sent to the decomposition part 31 from the pipe 25 as the exhaust gas which has low ethylene oxide concentration.

Thus, in the buffer part 21, ethylene oxide concentration in the exhaust gas discharged from the sterilization part 11, which gas has large variation in ethylene oxide concentration, can be reduced. That is, in the buffer part 21, the concentration of the ethylene oxide of the exhaust gas becomes a concentration which is not greater than the highest concentration of the ethylene oxide comprised in the exhaust gas sent from the sterilization part 11, and then it is sent into the decomposition part 31 from the buffer part 21. The example of temporal change in ethylene oxide concentration in the exhaust gas supplied to the decomposition part 31 from this buffer part 21 is shown in FIG. 6 with a dashed line (B).

The dashed line B of FIG. 6 shows temporal change in the concentration of the ethylene oxide prior to being sent to the decomposition part 31 subsequent to the discharge from the buffer part 21. This variation is similar to the variation of the ethylene oxide concentration of the exhaust gas in the prior art. Due to the buffer part 21, ethylene oxide concentration has been reduced in advance. Accordingly, in the initial stage, ethylene oxide concentration (a′) is much lower than the ethylene oxide concentration in the gas which is discharged from the sterilization part 11 (without a buffer part 21). The reason for this is that ethylene oxide is dissolved in water. However, if comparison between concentrations is conducted after a predetermined time has passed from the start of processing, first, ethylene oxide concentrations of A and B are reversed as shown by concentration (b′). This is because the water of the buffer part 21 is saturated with ethylene oxide, and the ethylene oxide which has not been dissolved in water is discharged as it is. Since the buffer part 21 is provided, rapid change of concentration is not seen even when intermittent introduction of the outside air in the sterilization chamber 12 is carried out to release the ethylene oxide adhering to gauze and the like. As a result, the concentration of ethylene oxide can approach to constant value gradually. Furthermore, when the aforementioned introduction is continued to conduct bubbling in the buffer part 21, ethylene oxide dissolving in water passed out of the solution and is discharged, and thereby the ethylene oxide concentration is further decreased.

While the aforementioned operation of the buffer part 21 is conducted, a valve 27 may be opened to introduce outside air from the pipe 26, and the introduced air may be bubbled from the gas diffusing pipe 23. By setting the timing of bubbling with the outside air properly, it is possible to control the degree of the decrease of the ethylene oxide concentration in this buffer part 21.

The degree of the decrease of the ethylene oxide concentration in this buffer part 21 may be set according to throughput of the decomposition part 31 which is downstream of this part. It is sufficient for the present invention in which the ethylene oxide concentration from the buffer part 21 may be controlled to be less than the highest concentration of the ethylene oxide in an exhaust gas, and also controlled so that a value (adsorption amount) obtained by subtracting the integration value of the decomposition ability of a photocatalyst or a photocatalyst and plasma from the integration value of the injection concentration (injection amount), from the start of processing to the time wherein a predetermined time has been passed, is not greater than the adsorption ability of the photocatalyst. It is preferable that the ethylene oxide concentration after processing in the buffer part 21 be not greater than 3% which is the explosion limit of ethylene oxide. The control method and the measurement method for the control and/or the integration, the condition, the device, instrument, the installation location, the measurement position thereof and the like can be arbitrary selected in the present invention. The integration value may be the total value. The aforementioned point and the calculation method and the like for integration may be determined and selected optionally. For example, it may be a time wherein one processing is end. Further, although the value of the highest concentration of the ethylene oxide may be changed in accordance with the use, conditions and the like, the present invention can be used in those cases since the use, conditions and the like of the present invention may be selected in accordance with the use, conditions and the like.

The exhaust gas from the buffer part 21 is sent to the decomposition part 31 through the pipe 25, and then decomposition processing for the gas is carried out. Decomposition processing in the decomposition part 31 is performed by the photocatalyst member which has ethylene oxide adsorption ability, or the combined use of the photocatalyst member and plasma decomposition device.

Decomposition processing of the ethylene oxide by the photocatalyst member or the photocatalyst member and the plasma proceeds at low temperature, and therefore the exhaust gas after the decomposition processing has a low temperature of 100° C. or less. Further, since the ethylene oxide concentration in the exhaust gas which flows into the decomposition part 31 is low, ethylene oxide can be decomposed completely and undecomposed ethylene oxide is not discharged therefrom.

Since the ethylene oxide concentration comprised in the exhaust gas which flows into the decomposition part 31 is reduced by the buffer part 21, a photocatalyst member can adsorb ethylene oxide completely and the photocatalyst member decomposes the adsorbed ethylene oxide gradually. Here, the term of adsorption means physical and chemical adhesion on the substance surface. As a result, non-decomposed ethylene oxide is not discharged to the outside. As the decomposing ability of the decomposition part 31, the ability wherein ethylene oxide is completely decomposed is not required essentially at that time. When the ethylene oxide can be adsorbed completely, the ethylene oxide is stored temporary by the adsorption, and therefore even if the decomposition ability of the decomposition part is low, it can be used due to the save of the ethylene oxide provided by the adsorption. In other words, even if the decomposition ability at that time does not satisfy the concentration at that time, there is no problem as described above by controlling a value (adsorption amount), which is obtained by subtracting the value obtained by integrating the decomposition ability of a photocatalyst or a photocatalyst and plasma from the value obtained by integrating the injection concentration (injection amount), from the start of processing to the point wherein a predetermined time is passed, to be not greater than the adsorption ability of the photocatalyst.

That is, the adsorption rate may seem to proceed more quickly than the decomposition rate. By such a state, the photocatalyst member does not need to be a member which can decompose ethylene oxide at high concentration. Therefore, since the decomposition processing can be conducted sufficiently even if a photocatalyst member having low throughput and the like is used, and the overall facility can be reduced in size and simplified.

A photocatalyst is originally hydrophilic, and the photocatalyst itself has the ability to adsorb ethylene oxide. Furthermore, when the material which has the hydrophilic property and/or adsorbing ability such as zeolite, silica gel, diatomite and the like is used as a carrier or a substrate, the carrier or a substrate can also have the adsorbing ability for the ethylene oxide. Accordingly, if the exhaust gas containing high concentration ethylene oxide flows to the photocatalyst member from the buffer part 21, the photocatalyst member once adsorbs the high-concentration ethylene oxide and decomposes this gradually. Therefore, non-decomposed ethylene oxide does not flows to the exhaust part 41 and this is desirable.

Subsequently, the exhaust gas in which decomposition processing is carried out in the decomposition part 31 and ethylene oxide is not contained therein is attracted in the exhaust part 41 through the pipe 42. Then, it is discharged from the pipe 43 to the outside of the system as a harmless clean gas.

The buffer part 21 and the decomposition part 31 are always provided at a negative pressure by the exhaust part 41 in the processing. Therefore, even when the buffer part 21, the decomposition part 31, and pipe lines are damaged, an exhaust gas does not leak to the outside.

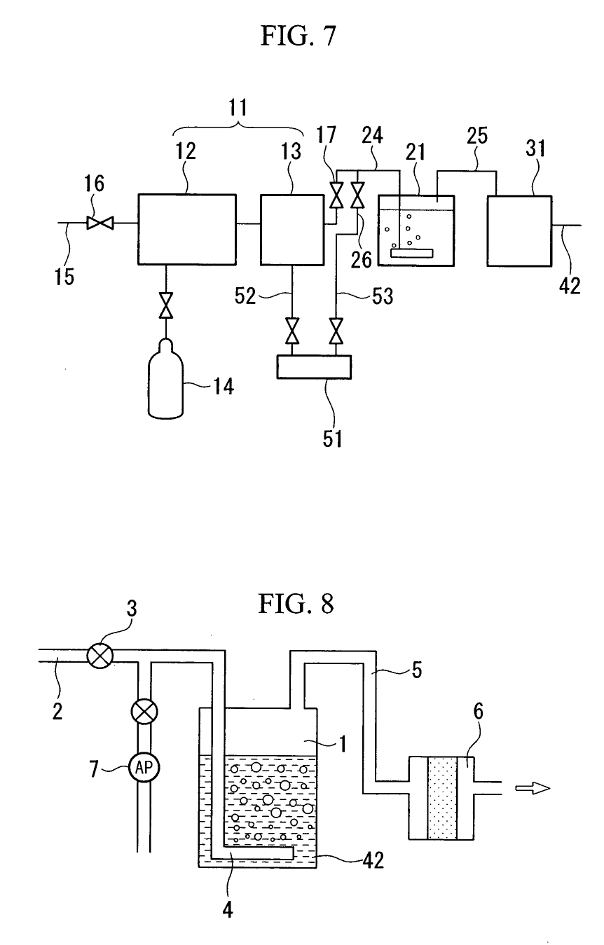

FIG. 7 shows another example of the decomposition processing device of the present invention. The numbers used for components in the figure are the same as those used in FIG. 1, and the explanation is simplified.

In the device of the example, the compressed air source 51 is provided, and the compressed air can be supplied from this source 51 to an ejector 13 from a pipe 52, and also can be supplied to the gas diffusing pipe 23 of the buffer part 21 via the pipes 26 and 24 from the pipe 53. The exhaust part 41 which was provided in a previous example does not exist in the case.

In the decomposition processing method using this decomposition processing device, the aeration conducted in the aeration tank of the buffer part 21 and the inflow of the exhaust gas from pipe 25 into the decomposition part 31 are conducted by supplying a compressed air from the compressed air source 51.

As an example of another applicable embodiment in the present invention, decomposition processing in the decomposition part 31 may be carried out by the action of plasma and adsorbent which have an ethylene oxide adsorbing ability, such as zeolite, silica gel, diatom earth and the like, without using a photocatalyst. The adsorbent which can be used in the present invention may be used alone or in combination of two or more.

The ethylene oxide in the exhaust gas sent from the buffer part 21 is once adsorbed to the adsorbent in this configuration, and then the adsorbed ethylene oxide is gradually subjected to decomposition processing due to the decomposition action of the plasma. In this way, although processing efficiency decreases to some extent, the effect of action similar to those of the previous embodiment can be also obtained in this embodiment.

Examples of the concrete configuration of the processing device of the embodiment include those using adsorbent such as zeolite, silica gel, diatom earth and the like instead of the photocatalyst member 35 of FIGS. 3, 4, and 5.

The buffer part 21 may comprise two or more aeration tanks and the like. For example, two or more aeration tanks which comprises the tank 22 and the gas diffusing pipe 23 are provided in series, and therefore aeration may be conducted as two or more steps. The temporal variation of the ethylene oxide concentration in the gas sent to the part 31 is more equalized by the configuration, and therefore further small decomposition ability in the decomposition part 31 can be acceptable by the configuration.

The adsorption column and the like which are filled up with the adsorbent having capability to adsorb ethylene oxide such as zeolite, silca gel, diatom earth and the like are also usable as the buffer part 21 of the present invention, instead of the use of the water tank 22 shown in FIG. 2. When the exhaust gas in which high concentration ethylene oxide is contained flows into the adsorption column, most of the ethylene oxide can be adsorbed thereto. Next, when the exhaust gas in which ethylene oxide is hardly contained flows into the adsorption column, the ethylene oxide migrates from the adsorbent into an exhaust gas due to desorption by the concentration gradient. In this way, even if the exhaust gas which contains high concentration ethylene oxide flows into the adsorption column, low concentration ethylene oxide flows out from the adsorption column, and therefore it functions as a buffer part 21.

As described above, in the present invention, the exhaust gas comprising ethylene oxide is once introduced into the buffer part 21 which can reduce the concentration of the ethylene oxide in the exhaust gas, and subsequently the exhaust gas wherein the amount of ethylene oxide is reduced is sent to the decomposition part 31 provided with a photocatalyst member such as titanium oxide which has an ability to adsorb ethylene oxide, or the photocatalyst member and plasma device, and ethylene oxide can be decomposed in the part. The decomposition processing in the decomposition part 31 may be carried out by using the adsorbent which has ethylene oxide adsorption ability such as zeolite and plasma device.

Examples which cause the variation of the ethylene oxide concentration in the gas in the present invention may include cases in which the variation occurs due to amounts, kinds, quality, concentration and the like of the gas which is sent to the device, wherein the device is used for a sterilization processing, in order to remove the gas from a processed product. However, the reasons for the changes may be other reasons. The present invention can be used without limiting the reason of the variation of the concentration.

Concrete examples are described below.

The exhaust gas (100% ethylene oxide) is aerated in water, and the ethylene oxide concentration of the exhaust gas discharged from the buffer part 21 is controlled to 2,000 ppm. Concretely, the control is conducted by controlling the amount of water in the buffer part 21 and the amount of bubbling air. The ethylene oxide concentration discharged may be arbitrarily determined in the range of 2000 or more and 4000 ppm or less. The photocatalyst member in which the decomposition ability thereof can process 1,000 ppm ethylene oxide at a rate of 3 L/min is used in the example. Regarding the decomposition ability, the amount of catalyst and the contact time with the catalyst can be adjusted in accordance with air flow. The gas exceeding decomposition ability is introduced into the decomposition part 31. Since the ethylene oxide in the gas is mainly decomposed at first, the decomposition ability becomes 1000 ppm (3 L/min) due to the rate controlling of the decomposition ability of the photocatalyst which is 1000 ppm (3 L/min). At the same time, there is ethylene oxide which is adsorbed to the photocatalyst without the decomposition thereof. The ethylene oxide concentration in the gas becomes lower than those of the decomposition ability of the catalyst after five hours have been passed. The photocatalyst is adsorbing ethylene oxide, and the photocatalyst decomposes the ethylene oxide by excess ability thereof. 10 hours later, the concentration of the ethylene oxide in the gas becomes nearly 0 ppm.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

The present invention is applicable also to decomposition processing of the ethylene oxide discharged from various types of the device for organic synthesis which uses ethylene oxide as a raw material, in addition to the processing for the ethylene oxide used for the medical applications. The present invention provides a decomposition processing method and a device in which, when decomposition processing of the exhaust gas containing the ethylene oxide from sterilization device and the like is carried out, exhaust gas after the decomposition processing does not have a high temperature, and even if the exhaust gas which contains high concentration ethylene oxide flows into a decomposition processing device for some reason, undecomposed ethylene oxide is not discharged to the outside of the system.

1. A decomposition processing method for ethylene oxide, wherein concentration of the ethylene oxide to be decomposed in a gas varies, the method comprising the steps of:
reducing the concentration of ethylene oxide in the gas to a predetermined concentration which is less than the highest concentration of the ethylene oxide in the range of the variation;
adsorbing the ethylene oxide by a photocatalyst which has ethylene oxide adsorbing ability; and
decomposing the ethylene oxide by action of one of the photocatalyst and a combination of the photocatalyst and plasma,
the adsorbing step and decomposing step are conducted after the reducing step.

2. The decomposition processing method for ethylene oxide according to claim 1, wherein the reducing step comprises a sub-step wherein the predetermined concentration of ethylene oxide is controlled so that:
the predetermined concentration of ethylene oxide is determined not to exceed the adsorbing ability of the photocatalyst; and
a value, which is obtained by subtracting an integral value of decomposition ability of one of the photocatalyst and the combination of the photocatalyst and the plasma from the start of processing to a point wherein a predetermined time is passed from the start from an integral value of injection concentration of the ethylene oxide from the start of processing to a point wherein a predetermined time is passed from the start, does not exceed the adsorbing ability of the photocatalyst.

3. The decomposition processing method for ethylene oxide according to claim 1, wherein a rate of the decomposition is lower than a rate of the adsorption.

4. The decomposition processing method for ethylene oxide according to claim 1, wherein control of the predetermined concentration of ethylene oxide is conducted by an aeration of the gas comprising ethylene oxide in water.

5. The decomposition processing method for ethylene oxide according to claim 4, wherein the overall decomposition processing system has a negative pressure.

6. A decomposition processing method for ethylene oxide, wherein the concentration of the ethylene oxide to be decomposed in a gas varies, and the method comprising the steps of:
reducing an ethylene oxide concentration in a gas to a predetermined concentration which is less than the highest concentration of the ethylene oxide in the range of the variation;
adsorbing ethylene oxide to an adsorbent which has ethylene oxide adsorbing ability; and
decomposing ethylene oxide by action of plasma, and
the adsorbing step and decomposing step are conducted after the reducing step.

7. The decomposition processing method for ethylene oxide according to claim 6, wherein the reducing step comprises a sub-step of controlling the predetermined concentration of ethylene oxide, wherein:
the predetermined concentration of ethylene oxide is determined not to exceed the adsorbing ability of the photocatalyst; and
a value, which is obtained by subtracting the integral value of decomposition ability of the plasma from the start of processing to a point wherein a predetermined time is passed from the start from the integral value of injection concentration of the ethylene oxide from the start of processing to a point wherein a predetermined time is passed from the start, does not exceed the adsorbing ability of the adsorbent.

8. The decomposition processing method for ethylene oxide according to claim 6, wherein rate of the decomposition is lower than rate of the adsorption.

9. The decomposition processing method for ethylene oxide according to claim 6, wherein the control of the predetermined concentration of ethylene oxide is conducted by an aeration of the gas comprising ethylene oxide in water.

10. The decomposition processing method for ethylene oxide according to claim 9, wherein the overall decomposition processing system has a negative pressure.

11. A decomposition processing device for ethylene oxide in which concentration of the ethylene oxide to be decomposed in a gas varies, wherein the device comprises: a buffer part which reduces ethylene oxide concentration in a gas to a predetermined concentration which is less than the highest concentration of the ethylene oxide in the range of the variation; and a decomposition part which decomposes ethylene oxide in the gas sent from the buffer part, wherein the decomposition part comprises one of a photocatalyst member which has ethylene oxide adsorbing ability and a combination of the photocatalyst member and a plasma device.

12. The decomposition processing device for ethylene oxide according to claim 11, wherein the buffer part is an aeration tank which has a tank filled with a water and an air diffusing pipe for bubbling the ethylene oxide in water.

13. The decomposition processing device for ethylene oxide according to claim 11, wherein an exhauster is provided to a downstream part of the decomposition part, and the exhauster provides negative pressure to the buffer part and the decomposition part.

14. A decomposition processing device for ethylene oxide in which concentration of the ethylene oxide to be decomposed in a gas varies, wherein the device comprises: a buffer part which reduces the ethylene oxide concentration in the gas to a predetermined concentration which is less than the highest concentration of the ethylene oxide in the range of the variation; and a decomposition part which decomposes ethylene oxide in the gas sent from the buffer part, wherein the decomposition part comprises an adsorbent which has ethylene oxide adsorbing ability and a plasma device.

15. The decomposition processing device for ethylene oxide according to claim 14, wherein the buffer part is an aeration tank, which has a tank filled with water and an air diffusing pipe for bubbling the ethylene oxide in the water.

16. The decomposition processing device for ethylene oxide according to claim 14, wherein an exhauster is provided to a downstream part of the decomposition part, and the exhauster provides negative pressure to the buffer part and the decomposition part.
